(19) United States
(12) Patent Application Publication
(10) Pub. No.: US 2026/0361013 A1
(43) Pub. Date: Nov. 12, 2026

(54) FPC CONNECTOR AND CONNECTOR PAIR

(71) Applicant: Molex, LLC, Lisle, IL (US)

(72) Inventor: Tetsunori Tsumuraya, Yamato (JP)

(21) Appl. No.: 19/139,402

(22) PCT Filed: Dec. 1, 2023
(86) PCT No.: PCT/IB2023/062111

§ 371 Date: Jun. 16, 2025

(30) Foreign Application Priority Data
Dec. 22, 2022 (JP) 2022-205747

(51) Int. Cl. H01R 12/77; H01R 12/70; H01R 13/506; H01R 13/627; H01R 13/641

(52) U.S. Cl. CPC H01R 12/774; H01R 12/7052; H01R 12/772; H01R 13/506; H01R 13/6272; H01R 13/641

(57) ABSTRACT

An independent locking member provided with a jacket housing into which an FPC can be inserted and an independent locking member that can be mounted to the jacket housing; the independent locking member includes a locking part that prevents removal of the FPC and a holding part that is held in the housing jacket; the FPC includes a notch formed at both width direction ends thereof, that is a notch into which the locking part is inserted; the holding part engages the jacket housing and includes an engaging part that can hold the independent locking member in a temporary holding position and a permanent holding position; and the locking part includes an upper surface through which the FPC can be inserted when the independent locking member is in the temporary holding position and an engaging part that engages the notch of the FPC when the independent locking member is in the permanent holding position.

### RELATED APPLICATION

This application claims priority to Japanese patent Application No. 2022-205747, filed Dec. 22, 2022, the contents of which is incorporated by reference herein in its entirety.

### TECHNICAL FIELD

The present disclosure relates to a FPC connector and connector pair.

### BACKGROUND

Conventionally, connectors for flexible flat cables have been used to connect flexible flat cables called flexible circuit boards (FPC), flexible flat cables (FFC), and the like. This manner of connector is attached on the tip end of the flexible flat cable, and by mating with a counterpart connector, conduction of the flexible flat cable with the counterpart connector is enabled (for example, see Patent Document 1).

FIG. 21 is an exploded view of a connector for a conventional flexible flat cable.

In the figure, 811 is a connector housing of the connector for the flexible flat cable for mating with a counterpart connector (not shown). The housing 811 is a flat box shaped member with a cavity for a cable stowing part formed therein and a flat plate part 812 protruding forward from a front surface thereof. The cable stowing part is open on a rear surface of the housing 811 and on both upper and lower sides of the flat plate part 812 on a front surface of the housing. Furthermore, an engaging opening 819 is open on both left and right sides on the upper surface of the housing 811, and a guide wall 813 is formed on both left and right sides of the flat plate part 812.

Moreover, 890 is an upper and lower pair of flexible flat cables. Each of the flexible flat cables 890 includes a plurality of conductors 892 that are mutually parallel and extend in the longitudinal direction thereof but an insulative covering that covers the upper surface of the conductors 892 is removed at a front end proximity part 891 of the flexible flat cable 890, exposing the conductors 892. Furthermore, a notch shaped holding part 893 is formed on both left and right ends of each of the flexible flat cables 890 to a prescribed length range from the front end proximity part 891, and a locking part 893a shaped so as to be further recessed toward the center of the flexible flat cable 890 in the width direction is formed in the middle of the holding part 893.

Additionally, 871 is a ground plate made of a metal plate provided between the upper and lower flexible flat cables 890. A plurality of elastic contacts 872 are formed in the ground plate 871 aligned in the width direction. Furthermore, a holding opening 873 is formed on both left and right proximity ends of the ground plate 871.

Additionally, 831 is a long narrow member extending in the width direction of the housing 811, and is a locking member mounted to the lower surface of the housing 811. A retaining part 832 is formed extending vertically on both ends of the locking member 831.

Note that 881 is a locking mechanism part made from a metal plate mounted to the upper surface of the housing 811 that, when a connector mates with a counterpart connector, engages the counterpart connector to configure a mechanism for maintaining the mating between the connector and the counterpart connector.

Furthermore, the pair of upper and lower flexible flat cables 890 are inserted into the housing 811 by moving the cables back to front with respect to the housing 811. At this time, the front end proximity part 891 of each of the flexible flat cables 890 passes through the cable stowing part of the housing 811 and advances on both upper and lower sides of the flat plate part 812 along the guide wall 813. Furthermore, ground plate 871 is provided between the upper and lower flexible flat cables 890. Finally, when the flexible flat cable 890 and the ground plate 871 reach a prescribed position, the locking member 831 is moved upward from below the housing 811 and is thus mounted to the housing 811. Thus, the upper end of both the left and right side retaining parts 832 passes through the locking part 893a of each of the flexible flat cables 890 and the holding openings 873 of the ground plate 871, and engages with the engaging opening 819 on the upper surface of the housing 811. Thus, the flexible flat cables 890 and the ground plate 871 are reliably mounted to the housing 811 of a connector.

Prior Art Documents: Patent Document 1: Japanese Unexamined Patent Application Publication 2020-072035

### SUMMARY

In general, mounting the flexible flat cable 890 to the conventional connector requires inserting the flexible flat cable 890 into the housing 811 and then, in addition, mounting the locking member 831, which is a separate member, to the housing 811, and is thus difficult and time consuming.

Furthermore, it is difficult to confirm whether the flexible flat cable 890 is completely inserted into the housing 811.

In addition, in recent years, connectors have become smaller and more low profile and various parts have been miniaturized, making it difficult to visibly confirm that the flexible flat cable 890 is completely inserted into the housing 811 and thus correctly mounted thereto.

Here, an object is to provide a highly reliable FPC connector and connector pair that resolves the problems of the conventional connector, and that, even though small and low profile, exhibits high strength, enables easy confirmation that a flexible circuit board (FPC) has been completely inserted into a housing, and can be mounted to the flexible circuit board simply, reliably, and correctly in a short period of time without the flexible circuit board falling out.

Therefore, in an FPC connector, an independent locking member provided with a jacket housing into which an FPC can be inserted and an independent locking member that can be mounted to the jacket housing; the independent locking member includes a locking part that prevents removal of the FPC and a holding part that is held in the housing jacket; the FPC includes a notch formed at both width direction ends thereof, that is a notch into which the locking part is inserted; the holding part engages the jacket housing and includes an engaging part that can hold the independent locking member in a temporary holding position and a permanent holding position; and the locking part includes an upper surface through which the FPC can be inserted when the independent locking member is in the temporary holding position and an engaging part that engages the notch of the FPC when the independent locking member is in the permanent holding position.

Additionally, in another FPC connector, the holding part is positioned further forward in an insertion direction of the FPC than the locking part.

In yet another FPC connector, the jacket housing includes a pair of protrusions formed on the front surface thereof, the holding part includes an opening part, and the engaging part of the holding part engages one of the pair of protrusions when the independent locking member is in the temporary holding position and engages the other of the pair of protrusions when the independent locking member is in the permanent holding position.

Additionally, in yet another FPC connector, the FPC includes an opening part formed closer to the front end than the notch, and the jacket housing includes a locking protruding part that engages the opening part.

Additionally, in yet another FPC connector, the locking part includes a slit part formed on a side surface thereof, and the upper surface thereof may be one of a plurality of surfaces that demarcate the perimeter of the slit part.

A connector pair includes a FPC connector according to the present disclosure and a counterpart connector that mates with the FPC connector.

With the present disclosure, the FPC connector, though small and low profile, exhibits high strength and can enhance reliability by making it easy to confirm that an FPC has been completely inserted into a housing, and by enabling simple, reliable, and correct mounting in a short period of time without the FPC falling out.

### BRIEF DESCRIPTION OF THE DRAWINGS

FIG. 1 is a perspective view of a first housing according to the present embodiment.

FIGS. 2A-2C are three views of the first housing according to the present embodiment, where FIG. 2A is a top view, FIG. 2B is a rear view, and FIG. 2C is a side view.

FIGS. 3A and 3B are perspective views of an independent locking member according to the present embodiment, where FIG. 3A is a view seen obliquely from the rear and FIG. 3B is a view seen obliquely from the front.

FIGS. 4A-4E are five views of the independent locking member according to the present embodiment, where FIG. 4A is a front view, FIG. 4B is a top view, FIG. 4C is a rear view, FIG. 4D is a cross sectional view along A-A in FIG. 4A, and FIG. 4E is a side view.

FIG. 5 is a perspective view of a first connector according to the present embodiment.

FIGS. 6A-6C are three views of the first connector according to the present embodiment, where FIG. 6A is a top view, FIG. 6B is a rear view, and FIG. 6C is a side view.

FIG. 7 is an exploded view of the first connector according to the present embodiment.

FIG. 8 is a plan view near a tip end of an FPC according to the present embodiment.

FIGS. 9A and 9B are two views illustrating a state just before the FPC is inserted in the first connector in a state where an ISL is temporarily held according to the present embodiment, where FIG. 9A is a perspective view and FIG. 9B is a top view.

FIG. 10 is a perspective view illustrating a state where the FPC is inserted into the first connector in a state where the ISL is temporarily held according to the present embodiment.

FIGS. 11A-11C are three views illustrating a state where the FPC is inserted into the first connector in a state where the ISL is temporarily held according to the present embodiment, where FIG. 11A is a top view, FIG. 11B is a rear view, and FIG. 11C is a side view.

FIGS. 12A and 12B are cross sectional views illustrating a state where the FPC is inserted into the first connector in a state where the ISL is temporarily held according to the present embodiment, where FIG. 12A is a perspective view that includes a cross sectional view along B-B in FIG. 11A, and FIG. 12B is a cross sectional view along B-B in FIG. 11A.

FIG. 13 is a perspective view illustrating a state where the FPC is completely mounted according to the present embodiment.

FIGS. 14A-14C are three views illustrating a state where the FPC is completely mounted according to the present embodiment, where FIG. 14A is a top view, FIG. 14B is a rear view, and FIG. 14C is a side view.

FIGS. 15A and 15B are cross sectional views illustrating a state where the FPC is completely mounted according to the present embodiment, where FIG. 15A is a perspective view that includes a cross sectional view along C-C in FIG. 14A, and FIG. 15B is a cross sectional view along C-C in FIG. 14A.

FIG. 16A and 16B are two views illustrating a state of an ISL when the FPC is incorrectly, or incompletely, inserted into the first connector according to the present embodiment, where FIG. 16A is a perspective view and FIG. 16B is a top view.

FIGS. 17A and 17B are cross sectional views illustrating a state of the ISL when the FPC is incorrectly, or incompletely, inserted into the first connector according to the present embodiment, where FIG. 17A is a perspective view that includes a cross sectional view along D-D in FIG. 16B, and FIG. 17B is a cross sectional view along D-D in FIG. 16B.

FIG. 18 is a perspective view illustrating a variation of the independent locking member according to the present embodiment.

FIG. 19 is a perspective view illustrating a relationship near the tip end of the FPC corresponding to the variation of the independent locking member according to the present embodiment.

FIGS. 20A and 20B are perspective views illustrating a second connector according to the present embodiment and a mated state between the first connector and the second connector, where FIG. 20A is a view illustrating the second connector, and FIG. 20B is a view illustrating a mated state between the first connector and the second connector.

FIG. 21 is an exploded view of a connector for a conventional flexible flat cable.

### DETAILED DESCRIPTION

Embodiments will hereinafter be described in detail with reference to the drawings.

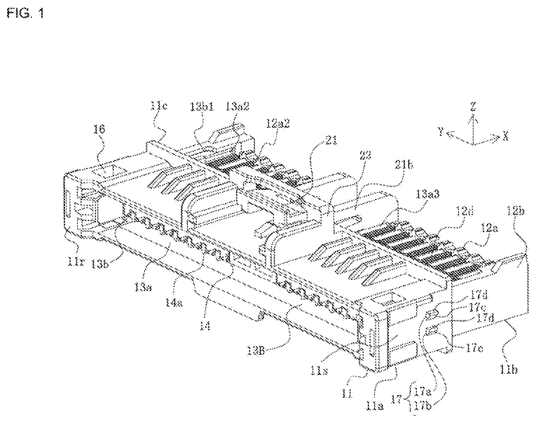

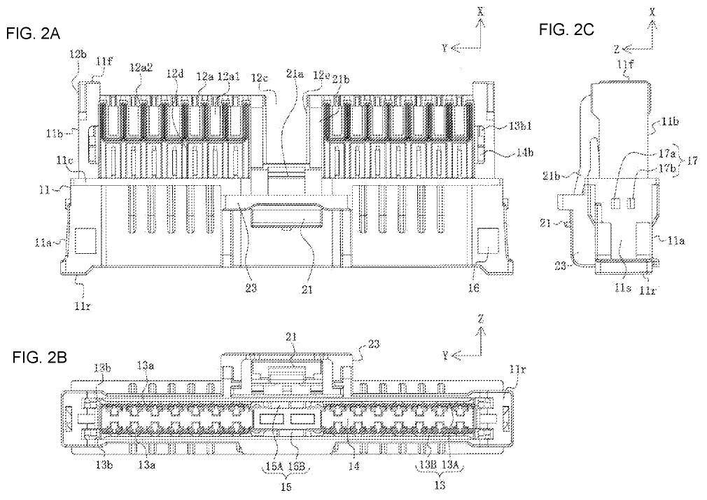

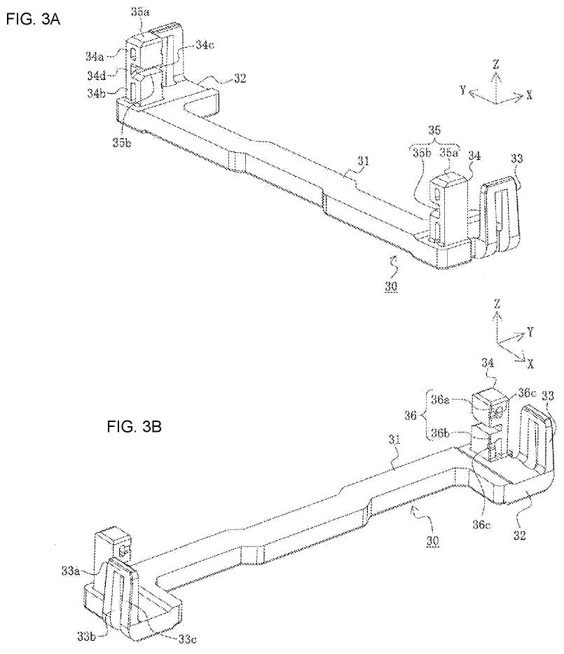

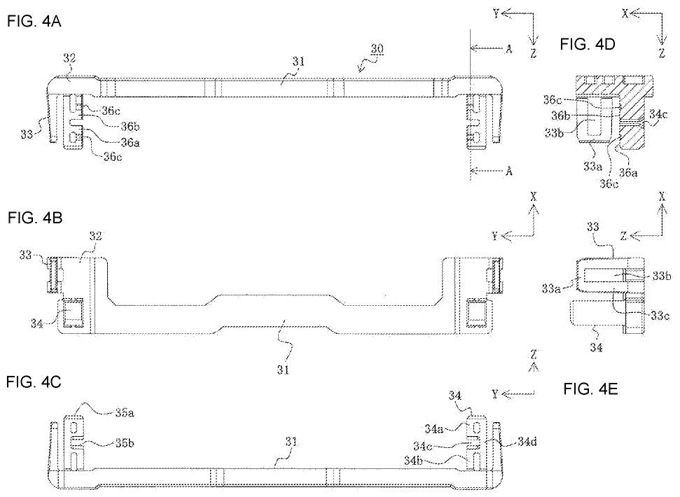

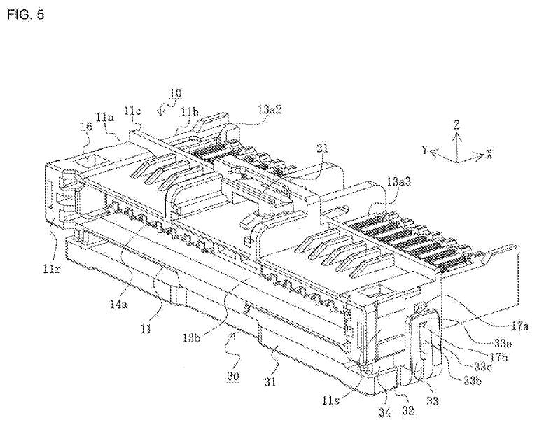

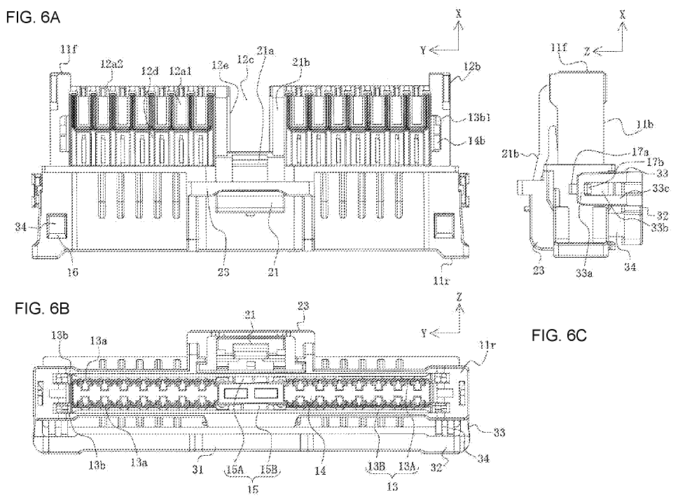

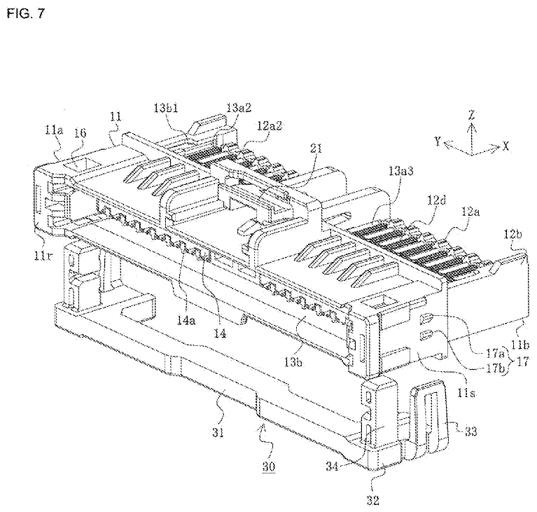

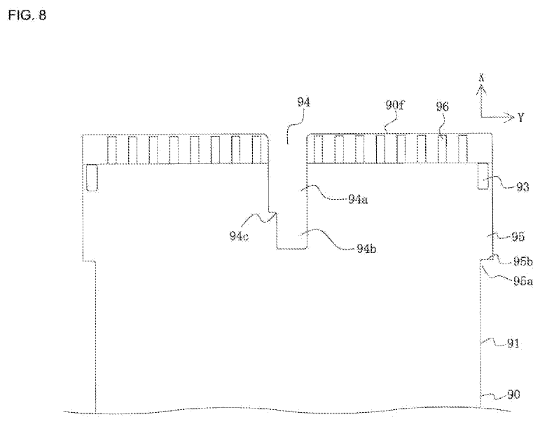

FIG. 1 is a perspective view of a first housing according to the present embodiment, FIGS. 2A-2Care three views of the first housing according to the present embodiment, FIGS. 3A and 3B are perspective views of an independent locking member according to the present embodiment, FIGS. 4A-4Eare five views of the independent locking member according to the present embodiment, FIG. 5 is a perspective view of a first connector according to the present embodiment, FIGS. 6A-6Care three views of the first connector according to the present embodiment, FIG. 7 is an exploded view of the first connector according to the present embodiment, and FIG. 8 is a plan view near a tip end of an FPC according to the present embodiment. Note that, in FIGS. 2A-2C, FIG. 2A is a top view, FIG. 2B is a rear view, and FIG. 2C is a side view; in FIGS. 3A and 3B, FIG. 3A is a view seen obliquely from the rear and FIG. 3B is a view seen obliquely from the front; in FIGS. 4A-4E, FIG. 4A is a front view, FIG. 4B is a top view, FIG. 4C is a rear view, FIG. 4D is a cross sectional view along A-A in FIG. 4A, and FIG. 4E is a side view; and in FIGS. 6A-6C, FIG. 6A is a top view, FIG. 6B is a rear view, and FIG. 6C is a side view.

In the figures, 10 is a first connector according to the present Embodiment, being one connector included in a connector pair that mates with a second connector 101, described below, as a counterpart connector. With the present Embodiment, the first connector 10 is a FPC connector mounted to a FPC 90 and used as a so-called jacket for electrically connecting the FPC 90, which is a flexible circuit board, to the second connector 101. Note that with the present Embodiment, FPC means not only flexible circuit boards but also flexible flat boards to flexible flat cables including a flexible flat cable called a FFC and may be any type of flexible flat board to flexible flat cable.

Furthermore, in the present embodiment, expressions indicating directions such as top, bottom, left, right, front, rear, and the like used to describe a configuration and operation of each unit of the first connector 10, the second connector 101, the FPC 90, and the like are relative rather than absolute, and are proper when each unit of the first connector 10, the second connector 101, the FPC 90, and the like are in positions illustrated in the drawings, but should be changed and interpreted according to a change in position when the posture changes.

Additionally, the first connector 10 includes a first housing 11 as a jacket housing and an Independent Secondary Lock (ISL) 30 as an independent locking member that is mounted to the first housing 11.

The first housing 11 is a member integrally formed from an insulating material such as a synthetic resin, or the like, and has a substantially rectangular body external shape elongated in the width direction (Y-axis direction). Furthermore, the first housing 11 includes a main body section 11a, being the side the FPC 90 is inserted into, or in other words, a rear side (X axis negative direction side), and a mating section 11b connected on the front surface (X axis positive direction side surface) of the main body section 11a that mates with the second connector 101. In addition, a flat plate shaped flange section 11c is formed extending in the width direction (Y axis direction) between the main body section 11a and a mating section 11b. Note that the rear end surface of the main body section 11a is called the rear surface 11r of the first housing 11 and the front end surface of the mating section 11b is called the front surface 11f of the first housing 11.

An engaging protruding part 17 is formed on a side surface 11s on both left and right sides of the main body part 11a as a pair of protrusions that are able to engage with an ISL 30. The engaging protruding part 17 includes a first engaging protruding part 17a as a permanent holding position engaging part that is able to engage with a locking spring part 33 of the ISL 30 when the ISL 30 is in a permanent holding position, and a second engaging protruding part 17b that is formed below the first engaging protruding part 17a at a prescribed interval as a temporary holding position engaging part that is able to engage with the locking spring part 33 when the ISL 30 is in a temporary holding position.

Note that the first engaging protruding part 17a and the second engaging protruding part 17b, when described collectively in the present embodiment, are described as an engaging protruding part 17.

Furthermore, each of the engaging protruding parts 17 is a substantially triangular column shaped member that extends front-to-back (X axis direction) and includes a top surface part 17d that is substantially orthogonal to the side surface 11s, and an inclined surface part 17c that extends in a downward diagonal direction from the outer end of the top surface part 17d.

The mating part 11b includes a mating side part 12b positioned on both ends thereof in the width direction (Y axis direction) and extending forward (X axis positive direction) from the flange part 11c, and a main mating part 12a demarcated on left and right ends by the mating side part 12b. Note that the front end surfaces of the mating side sections 12b function as the front surface 11f while the front end surface of the mating main section 12a is positioned back (X axis negative direction) from the front surface 11f. In addition, the main mating part 12a is provided with a plurality of terminal insertion recessed parts 12a1 into which at least a contact protrusion of a terminal (not shown) included on the second connector 101 is inserted when the first connector 10 and the second connector 101 are mated together, and which are formed lined up in the width direction. The quantity and pitch of the terminal insertion recessed part 12a1 are set to correspond to the quantity and pitch of the terminal. Note that each of the terminal insertion recessed sections 12a1 are formed with an opening on the front end surface of the mating main section 12a and also formed with an opening on mating main planes 12d above and below the mating main section 12a. The front end of the mating main planes 12d are demarcated by front end protrusion sections 12a2 that protrude up and down at the front end surface of the mating main section 12a.

Furthermore, a mating recessed section 12c is formed as a recessed section where the mating section 11b is missing in the middle of the mating main section 12a in the width direction (Y axis direction). As viewed from a vertical direction (Z axis direction), the mating recessed section 12c is a substantially rectangular space, indented from the front end surface of the mating main section 12a to the flange section 11c, and the left and right sides thereof are demarcated by mating internal wall sections 12e extending in the front-to-back direction as well as the up-and-down direction.

In addition, as a mated state retaining device for retaining a mated state with the second connector 101, a lock member 21 is formed in the middle in the width direction (Y axis direction) of the upper surface (Z axis positive direction surface) of the first housing 11. This lock member 21 includes a pair of locking arm sections 21b on the left and right and a lock protruding section 21a having both ends thereof connected to the middle sections of the locking arm sections 21b. Each of the locking arm sections 21b are elastically deformable cantilever type members with the base end thereof connected to the upper surface of the mating internal wall sections 12e that demarcate both sides of the mating recessed section 12c in the width direction and extend in a straight line in the rear direction (X axis negative direction), when viewed from a vertical direction (Z axis direction). Furthermore, a locking holding part 23 is formed on the upper surface of the main body part 11a rearward of the locking member 21 and a secondary locking member is mounted on the locking holding part 23 so as to be able to slide forward as a contact position assurance mechanism (CPA) (not shown). The secondary locking member functions in the same manner as a general CPA, and, upon completion of the mating of the first connector 10 and the second connector 101 and the locking of the second connector 101 with the locking member 21, is a member that, when slid forward, prevents the locking member 21 from moving in a mating release direction.

Furthermore, a board insertion recessed part 13 is formed in the first housing 11 as an FPC insertion recessed part into which at least a portion near a front end 90f of the FPC 90 is inserted. The board insertion recessed section 13 extends in the front-to-back direction (X axis direction), is a recessed section that opens in a narrow long slit manner extending in the width direction (Y axis direction) at the rear surface 11r of the first housing 11, and is demarcated into an upper side board insertion recessed section 13A and a lower side board insertion recessed section 13B by a partition wall 14 that extends in the width direction. In other words, the first housing 11 includes two board insertion recessed sections 13. Furthermore, an upper side FPC 90A of the FPC 90 is inserted into the upper side board insertion recessed part 13A and a lower side FPC 90B of the FPC 90 is inserted into the lower side board insertion recessed part 13B.

Note that in the present Embodiment, board insertion recessed section 13 will be used as a collective description of the upper side board insertion recessed section 13A and lower side board insertion recessed section 13B. Also, FPC 90 will be used as a collective description of the upper side FPC 90A and lower side FPC 90B.

Each of the board insertion recessed sections 13 include an end part insertion recess section 13b positioned at both ends in the width direction (Y axis direction) and a center insertion recessed section 13a connected on the left and right ends to the end part insertion recess sections 13b.

In the mating section 11b, the end part insertion recess sections 13b extend in the front-to-back direction within the mating side sections 12b and are open on the front end surface of the mating side sections 12b. Furthermore, a holding pillar stowing hole 16 into which an FPC holding pillar 34 of the ISL 30 can be inserted is open in the upper surface (Z axis positive direction surface) of the main body part 11a corresponding to the end part insertion recessed part 13b. The holding pillar stowing hole 16 extends vertically (Z axis direction), passes through the end part insertion recessed part 13b, and penetrates from the upper surface to the lower surface of the main body part 11a. Furthermore, a window 13b1 is formed on the upper surface and the lower surface of the mating side part 12b corresponding to the end part insertion recessed part 13b as a notch shaped viewing window extending front-to-back, and the end part insertion recessed part 13b inside the mating side part 12b connects to the upper and lower outer parts of the first housing 11 through the window 13b1; thus, the inside of the end part insertion recessed part 13b can be viewed through the window 13b1.

Moreover, the center insertion recessed part 13a connects to a space on the surface of the main mating plane 12d above and below the main mating part 12a. In other words, the front end 90f of the portion of the FPC 90 inserted into the center insertion recessed part 13a is able to slide along the surface of the main mating plane 12d and reach the front end protruding part 12a2 that demarcates the front end of the main mating plane 12d.

Furthermore, the end part insertion recess section 13b inside the mating side section 12b communicates with the space above the surface of the mating main planes 12d above and below the mating main section 12a through a side section communication opening 13a2 formed on the side surface in the mating side section 12b as a communication opening. Furthermore, the mating recessed section 12c communicates with the space above the surface of the mating main planes 12d above and below the mating main section 12a through a recessed communication opening 13a3 formed in the mating internal wall section 12e as a communication opening, being a slit. In other words, the portion of the FPC 90 inserted along the surface of the mating main planes 12d can be maintained in a state of connection with the portion inserted into the end part insertion recess section 13b in the mating side section 12b and a portion thereof can be exposed to the inside of the mating recessed section 12c.

A plurality of long and narrow ribs 14a protrude extending from the upper and lower surfaces within the center insertion recessed section 13a on the partition wall 14 in the front-to-back direction. Since the surface of the FPC 90 that is inserted in the board insertion recessed section 13 on the partition wall 14 side slides along the surface of the long and narrow ribs 14a, sliding resistance can be reduced enabling smooth sliding.

Furthermore, as is described below, a locking protruding part 14b is formed on upper and lower surfaces inside the end part insertion recessed part 13b in the partition wall 14 so as to protrude as a locking protruding part. Because the locking protruding part 14b is inserted into a locking opening part 93 formed in the width direction of the FPC 90 inserted into the board insertion recessed part 13, the FPC is kept from being needlessly removed.

Furthermore, column sections 15 extending in the vertical direction are formed in the first housing 11 inside the board insertion recessed sections 13. The column section 15 is a polygonal column shaped member with a substantially rectangular cross section and is formed near the center of the first housing 11 in the width direction with the front side surface (X axis positive direction surface) facing the mating recessed section 12c. Note that in the present Embodiment, the column section 15 positioned in the upper side board insertion recessed section 13A will be described as the upper side column section 15A and the column section 15 positioned in the lower side board insertion recessed section 13B will be described as the lower side column section 15B but when describing the upper side column section 15A and the lower side column section 15B collectively, column sections 15 will be used as the description.

Furthermore, the pillar part 15, when viewed from the vertical direction (Z axis direction), has a substantially rectangular cross sectional shape, the dimension in the width direction (Y axis direction) thereof is smaller than the dimension in the width direction (Y axis direction) of the mating recessed part 12c, and the center of the width direction thereof is biased to one side (for example, in the case of the upper side pillar part 15A, the Y axis positive direction side, and in the case of the lower side pillar part 15B, the Y axis negative direction) in the width direction from the center of the width direction of the mating recessed part 12c. Additionally, the front side surface of the pillar part 15 demarcates at least half of a rear end surface corresponding to the board insertion recessed part 13 in the mating recessed part 12c, and is exposed inside the mating recessed part 12c.

FIG. 8 is a plan view of a prescribed distance range from the front end 90f in the FPC 90 that illustrates a plan view illustrating a surface side of the FPC 90. Note that FPC 90 is generally a long band-shaped member but illustration of the section that is separated more than the aforementioned prescribed distance from the front end 90f is omitted for convenience of description. Furthermore, a flat plate shaped reinforcing plate 92 described below is mounted on a terminal contact surface that is a surface of a main body 91 of the FPC 90 that is in contact with the terminal of the second connector 101, that is, on a non-terminal contact surface on the opposite side of a front side surface, that is, a rear surface, within in a prescribed length range from the front end 90f. This reinforcing plate 92 is composed of, for example, an insulating resin film or the like and is desirably adhered to the back side surface of the main body 91 by adhesive or the like as a reinforcing member. Note that the prescribed length is desirably slightly longer than the length of the first housing 11 from the front end protrusion section 12a2 of the mating main section 12a to the rear surface 11r and that the vicinity of the rear end of the reinforcing plate 92 is visible when the FPC 90 is mounted on the first connector 10.

In addition, as is illustrated in FIG. 8, a specified area from the front end 90f of the front side surface of the main body 91 has an insulative coating removed and a conductor wire 96 is exposed. Note that the area with the insulative coating removed is desirably smaller than the area to which the reinforcing plate 92 is attached. A plurality of the conductor wires 96 (for example, roughly 16) extend in the longitudinal direction (X axis direction) of the FPC 90 and are arranged parallel at a prescribed pitch (for example, roughly 1 to 2 [mm]). Note that the quantity and pitch of the conductor wires 96 correspond to, and are suitably changed according to, the quantity and pitch of the terminals of the second connector 101.

The FPC 90 has a bifurcated tip and a separation section 94 recessed to the rear (X axis negative direction) is formed in the center of the front end 90f in the width direction (Y axis direction). The separation section 94 is a space where the main body 91 and the reinforcing plate 92 are missing and is a space opened at the front end 90f.

Furthermore, the separation part 94 has the shape illustrated in FIG. 8 as viewed from the vertical direction (Z axis direction) and includes a substantially rectangular main body part 94a with a large dimension in the width direction and a substantially rectangular protruding part 94b with a dimension in the width direction smaller than that of the main body part 94a protruding rearward (X axis negative direction) from the main body part 94a. Note that a center in the width direction of the main body part 94a matches a center in the width direction of the FPC 90. The protruding part 94b is formed with the center in the width direction thereof biased to one side (in the example illustrated in FIG. 8, the right side (Y axis negative direction side)) more than the center in the width direction of the main body part 94a, and the right side surface of the protruding part 94b and the right side surface of the main body part 94a configure the same surface. In addition, the left side surface of the protruding section 94b is positioned to the right of the left side surface of the main body section 94a and a protruding piece 94c is formed by demarcation with the two surfaces of the left side surface of the protruding section 94b and the rear side surface of the main body section 94a. The protruding piece 94c has a hook or rectangular planar shape as illustrated in FIG. 8.

The separation part 94 is a portion that engages the pillar part 15 and the protruding part 94b is the portion toward the rear end (X axis negative direction end) thereof that stows the pillar part 15. Therefore, when viewed from the vertical direction (Z axis direction), the shape of the protruding part 94b is the same as the cross section shape of the pillar part 15 and the dimensions in the width direction and front-to-back direction of the protruding part 94b are nearly the same as those of the pillar part 15 cross section. Note that the dimension of the width direction of the main body section 94a is slightly smaller than that of the mating recessed section 12c.

When insertion of the FPC 90 into the first connector 10 is complete, the pillar part 15 of the first housing 11 enters into and engages the separation part 94 formed in the center in the width direction of the FPC 90. Here, the upper side pillar part 15A and the lower side pillar part 15B are each biased more toward a different side in the width direction from the center in the width direction (Y axis direction) of the first housing 11 to the mating recessed part 12c. In the example illustrated in the drawing, the upper side pillar part 15A is biased to a Y axis positive direction side and the lower side pillar part 15B is biased to a Y axis negative side. Accordingly, only an FPC 90 with normal orientation, that is, only an FPC 90 oriented so that the surface side in which the conductor wire 96 is exposed is facing the vertical direction (Y axis direction) center of the first housing 11 can be inserted into the upper side board insertion recessed part 13A and the lower side board insertion recessed part 13B.

Furthermore, a tab 95 is formed protruding outward in the width direction to a prescribed length range from the front end 90f of the FPC 90. The width direction dimension of the tab 95 is larger than other portions. Furthermore, in the example illustrated in the drawings, the dimension of the prescribed length direction is larger than the separation part 94, but smaller than the reinforcing plate 92. Additionally, a hook or rectangular planar shaped notch 95a is formed in a position adjacent to the rear end of each of the tabs 95. The notch 95a is formed on both width direction ends of the FPC 90, and the front end thereof, that is, the rear end of the tab 95, becomes an engaging edge part 95b that engages the FPC holding pillar 34 of the ISL 30. Furthermore, the locking opening part 93 is formed in each of the tabs 95 in a position closer to the front end 90f than the notch 95a as an opening part than penetrates in a thickness direction (Z axis direction) of the FPC 90.

In the present embodiment, the ISL 30 is a member integrally formed from an insulating material such as a synthetic resin or the like, and that, as is illustrated in FIGS. 3A and 3B and FIGS. 4A-4E, includes a rod shaped main body part 31 elongated in the width direction and a protruding piece 32 that extends forward (X axis positive direction) from both ends of the main body part 31. Additionally, the locking spring part 33 is formed on a width direction outer end on the front end of the protruding piece 32 as a holding part that extends vertically. The locking spring part 33 is held in the first housing 11. Furthermore, the FPC holding pillar 34 is formed near the rear end of the protruding piece 32 as a locking part that extends vertically. The FPC holding pillar 34 is inserted into the notch 95a to prevent the FPC 90 from being removed from the first housing 11. Note that a left and right pair of the locking spring parts 33 is positioned further forward, and outside in the width direction, relative to the direction (X axis positive direction) in which the FPC 90 is inserted into the first housing 11 than is a left and right pair of the FPC holding pillars 34.

The locking spring part 33, when viewed from the side surface (Y axis direction), is roughly gate shaped and includes a pair of legs 33c that extend upward from the protruding piece 32, an engaging beam part 33a that extends front-to-back as an engaging part that connects the upper ends of the legs 33c together, and a space 33b formed between the legs 33c as an elongated opening part that extends vertically. The engaging beam part 33a engages the first engaging protruding part 17a and the second engaging protruding part 17b of the first housing 11, and is able to hold the ISL 30 in the temporary holding position and the permanent holding position. Additionally, because the leg 33c functions as a cantilevered elastic member the lower end of which is restrained by the protruding piece 32, the engaging beam part 33a can be elastically displaced in the width direction.

Furthermore, the FPC holding pillar 34, when viewed from the vertical direction (Z axis direction), is a roughly rectangular square column shaped member, and is divided into an upper side block 34a and a lower side block 34b by a slit part 34c formed near the middle in the height direction extending front-to-back direction. Note that the width direction dimension of the slit part 34c is smaller than the FPC holding pillar 34, but at least half as big as the FPC holding pillar 34, the part extends front-to-back direction and in the width direction, and is formed open in the front side surface, the rear side surface, and the width direction inside surface of the FPC holding pillar 34. Additionally, the upper side block 34a and the lower side block 34b are connected together by a connecting part 34d that remains outside the slit part 34c in the width direction.

Note that the upper end surface of the FPC holding pillar 34, that is, the upper end surface of the upper side block 34 a, is called an upper side upper surface 35a; and the lower surface of the slit part 34c, that is, the upper end surface of the lower side block 34b is called a lower side upper surface 35b. In other words, one of the plurality of surfaces demarcating a perimeter of the slit part 34c is called the lower side upper surface 35b. Furthermore, the front end surface of the upper side block 34a is called an upper side engaging part 36a, and the front end surface of the lower side block 34b is called a lower side engaging part 36b. Additionally, it is preferable that a recessed groove shaped recessed part 36c be formed extending in the width direction on at least parts of the upper side engaging part 36a and the lower side engaging part 36b.

Moreover, in the present embodiment, the upper side upper surface 35a and the lower side upper surface 35b are, when described collectively, described as an upper surface 35; and the upper side engaging part 36a and the lower side engaging part 36b, when described collectively, are described as an engaging part 36. The upper surface 35 is a surface by which the FPC 90 can be inserted when the ISL 30 is in the temporary holding position, and the engaging part 36 is a portion that engages the notch 95a of the FPC 90 when the ISL 30 is in the permanent holding position.

The ISL 30 is mounted to the first housing 11 from a lower side of the first housing 11. Specifically, as is illustrated in FIG. 7, the ISL 30 is mounted to the first housing 11 by being moved so as to rise relative to the first housing 11 from an orientation where the upper surface of the main body part 31 faces the lower surface of the first housing 11. At this time, the FPC holding pillar 34 is inserted into the holding pillar stowing hole 16 that is open in the lower surface of the main body part 11a, and the locking spring part 33 is raised relative to the main body part 11a along the side surface 11s. When the locking spring part 33 rises relatively along the side surface 11s, the engaging beam part 33a makes contact with the second engaging protruding part 17b. Here, because the inclined surface part 17c is formed on the lower surface of the second engaging protruding part 17b, the engaging beam part 33a is able, while elastically displacing outward in the width direction of the first housing 11, to smoothly ride up over the second engaging protruding part 17b. Additionally, after riding up over the second engaging protruding part 17b, the engaging beam part 33a returns inward in the width direction of the first housing 11 through elastic force.

Thus, as is illustrated in FIG. 5 and FIGS. 6A-C, the engaging beam part 33a engages the second engaging protruding part 17b in the temporary holding position, and the ISL 30 is temporarily held in the main body part 11a of the first housing 11 in the temporary holding position. In this state, the engaging beam part 33a not only engages the second engaging protruding part 17b but is also positioned just below the first engaging protruding part 17a, and thus the ISL 30 does not move significantly vertically. Furthermore, although a lower end proximity of the FPC holding pillar 34 is not stowed in the holding pillar stowing hole 16, the pillar is, to a certain degree, stowed in the holding pillar stowing hole 16 from an upper end. Accordingly, the ISL 30 does not rattle significantly against the first housing 11, despite being in the temporary holding position.

An operation for mounting the FPC 90 to the first connector 10 is described below.

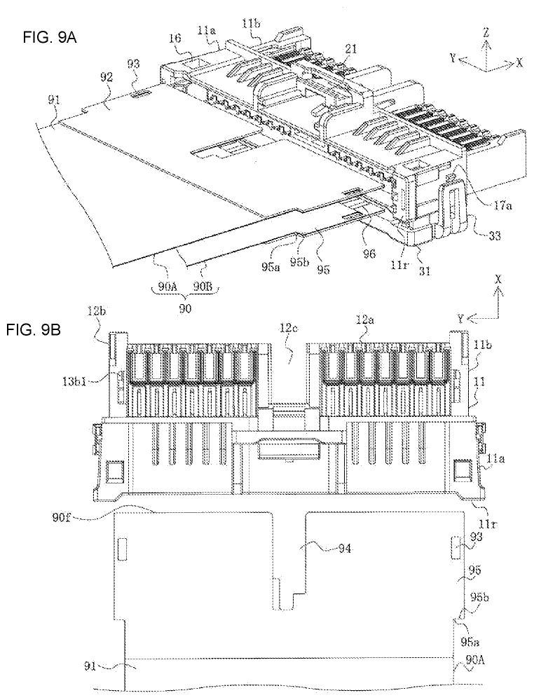

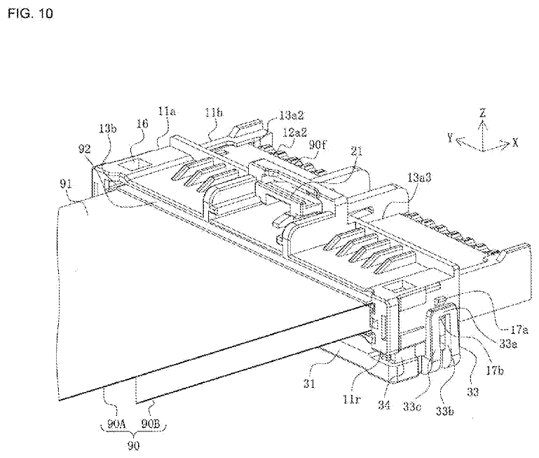

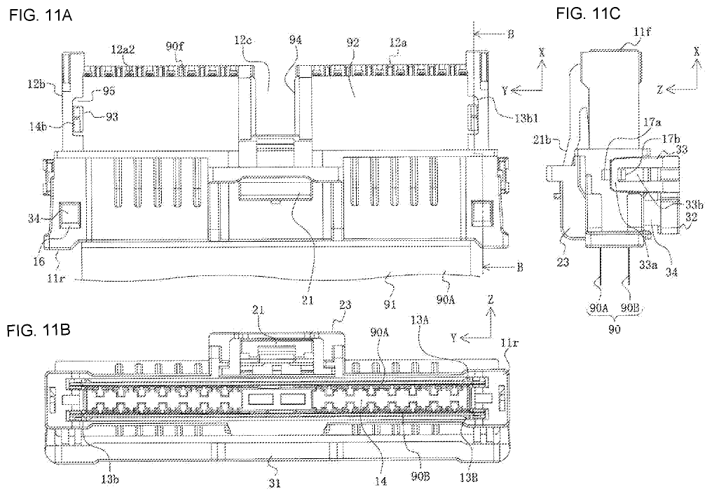

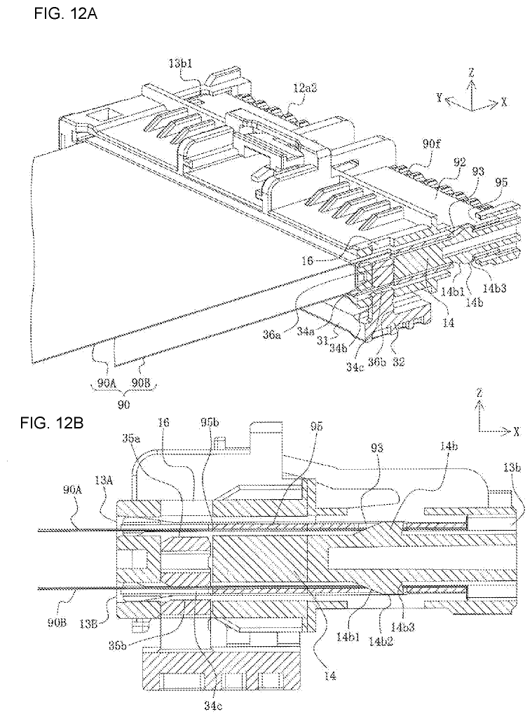

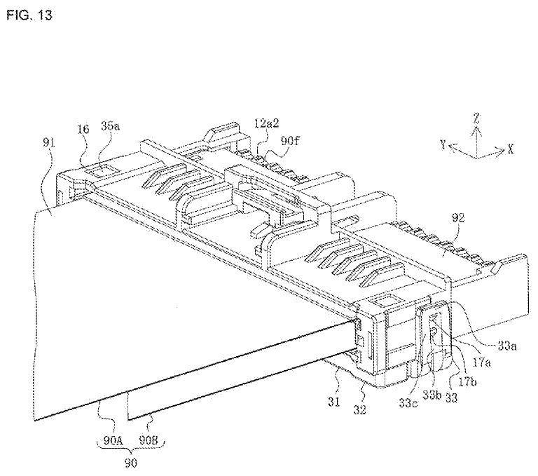

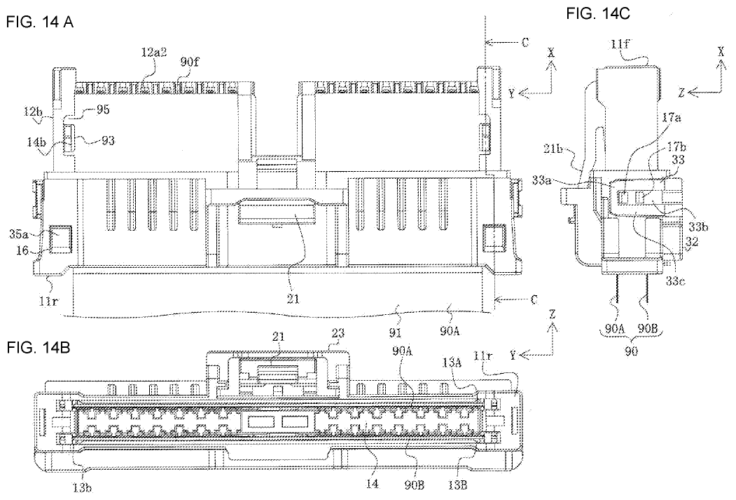

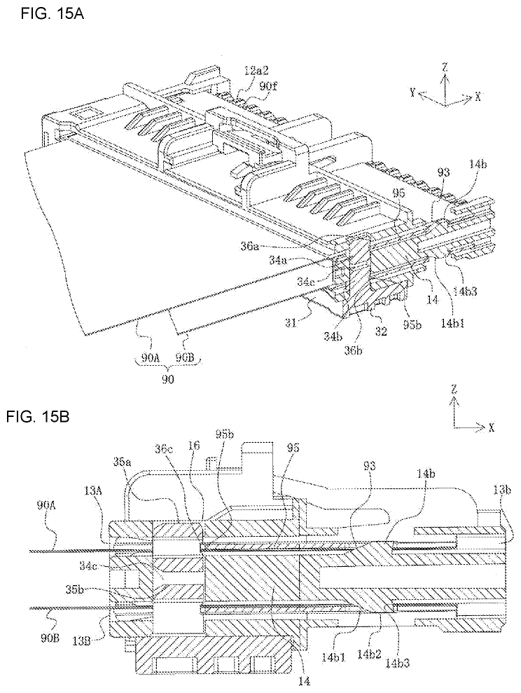

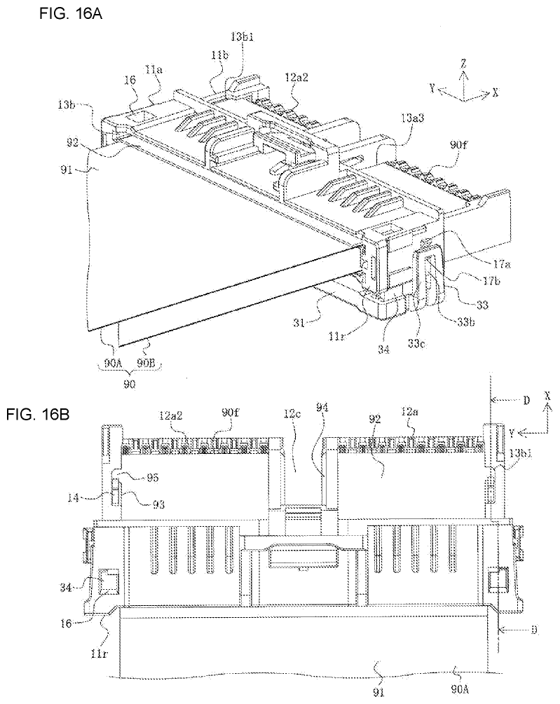

FIGS. 9A and 9B are two views illustrating a state just before the FPC is inserted in the first connector in a state where an ISL is temporarily held according to the present embodiment, FIG. 10 is a perspective view illustrating a state where the FPC is inserted into the first connector in a state where the ISL is temporarily held according to the present embodiment, FIGS. 11A-11C are three views illustrating a state where the FPC is inserted into the first connector in a state where the ISL is temporarily held according to the present embodiment, FIGS. 12A and 12B are cross sectional views illustrating a state where the FPC is inserted into the first connector in a state where the ISL is temporarily held according to the present embodiment, FIG. 13 is a perspective view illustrating a state where the FPC is completely mounted according to the present embodiment, FIGS. 14A-14Care three views illustrating a state where the FPC is completely mounted according to the present embodiment, and FIGS. 15A and 15B are cross sectional views illustrating a state where the FPC is completely mounted according to the present embodiment. Note that, in FIGS. 9A and 9B, FIG. 9A is a perspective view and FIG. 9 B is a top view; in FIGS. 11A-11C, FIG. 11A is a top view, FIG. 11B is a rear view, and FIG. 11C is a side view; in FIGS. 12A and 12B, FIG. 12A is a perspective view that includes a cross sectional view along B-B in FIG. 11A and FIG. 12B is a cross sectional view along B-B in FIG. 11A; in FIGS. 14A-14C, FIG. 14A is a top view, FIG. 14B is a rear view, and FIG. 14C is a side view; and, in FIGS. 15A and 15B, FIG. 15A is a perspective view that includes a cross sectional view along C-C in FIG. 14A and FIG. 15B is a cross sectional view along C-C in FIG. 14A.

The FPC 90 is inserted through the rear surface 11r of the first housing 11 and into the board insertion recessed part 13 for mounting to the first connector 10. Specifically, as is illustrated in FIGS. 9A and 9B, from an orientation of the front end 90f thereof facing the rear surface 11r of the first housing 11, the FPC 90 is moved forward relative to the first housing 11 and inserted into the board insertion recessed part 13. Here, with an orientation of the front side surface, the surface on which the reinforcing plate 92 is not attached, facing the partition wall 14, the upper side FPC 90A is inserted into the upper side board insertion recessed section 13A and with the orientation of the front side surface, the surface on which the reinforcing plate 92 is not attached, facing the partition wall 14, the lower side FPC 90B is inserted into the lower side board insertion recessed section 13B.

Furthermore, because the ISL 30 is temporarily held in the main body part 11a of the first housing 11 in the temporary holding position, as is illustrated in FIGS. 12A and 12B, for the FPC holding pillar 34 inserted inside the holding pillar stowing hole 16 passing through the end part insertion recessed part 13b vertically, the slit part 34c is positioned at nearly the same height as the end part insertion recessed part 13b of the lower side board insertion recessed part 13B; the lower side upper surface 35b, which is the bottom surface of the slit part 34c, is positioned at the same height as, or below, the bottom surface of the end part insertion recessed part 13b of the lower side board insertion recessed part 13B; and the upper side upper surface 35a, which is the upper end surface of the FPC holding pillar 34, is positioned at the same height as, or below, the bottom surface of the end part insertion recessed part 13b of the upper side board insertion recessed part 13A. Thus, the tab 95 of the lower side FPC 90B is able to move relatively forward inside the end part insertion recessed part 13b of the lower side board insertion recessed part 13B and pass through the slit part 34c, that is, pass through above the lower side upper surface 35b, and the tab 95 of the upper side FPC 90A is able to move relatively forward inside the end part insertion recessed part 13b of the upper side board insertion recessed part 13A and pass through above the upper side upper surface 35a. In other words, because the ISL 30 is in the temporary holding position, the tab 95 of the FPC 90 is able to pass through above, and be inserted through, the upper surface 35 of the FPC holding pillar 34.

Additionally, when the tab 95 of the FPC 90 passes through above the upper surface 35 of the FPC holding pillar 34 and moves further relatively forward inside the end part insertion recessed part 13b, the front end 90f of the tab 95 makes contact with the locking protruding part 14b. Note that as is illustrated in FIG. 12B, each of the locking protruding parts 14b includes a top surface part 14b2 that extends front-to-back, an inclined surface part 14b1 connected to the rear end (X axis negative direction end) of the top surface part 14b2, and a locking surface part 14b3 connected to the front end (X axis positive direction end) of the top surface part 14b2 that extends vertically (Z axis direction). Thus, the inclined surface part 14b1 is formed on the rear end side of the locking protruding part 14b so the tab 95 can smoothly ride up onto the locking protruding part 14b and move further forward. Additionally, when the locking opening part 93 passes through the locking protruding part 14b, the locking protruding part 14b advances inside the locking opening part 93 and locks the locking opening part 93. Furthermore, the engaging edge part 95b, which is a rear end of the tab 95, is positioned further forward than the holding pillar stowing hole 16, and the holding pillar stowing hole 16 is inside notch 95a.

Additionally, the front end 90f of the portion of the FPC 90 inserted into the center insertion recessed part 13a slides along the surface of the main mating plane 12d, where upon reaching the front end protruding part 12a2, insertion of the FPC 90 into the first connector 10 is complete. Thus, as is illustrated in FIG. 10 to FIGS. 12A and 12B, the front end 90f of the FPC 90 makes contact with, or is in close proximity to, the front end protruding part 12a2.

When insertion of the FPC 90 into the first connector 10 is complete, the pillar part 15 of the first housing 11 enters into and engages the separation part 94 formed in the center in the width direction of the FPC 90. Specifically, the separation part 94 of the upper side FPC 90A engages the upper side pillar part 15A and the separation part 94 of the lower side FPC 90B engages the lower side pillar part 15B. Additionally, the pillar part 15 is stowed in the protruding part 94b in the separation part 94.

In the example illustrated in the drawing, the upper side pillar part 15A is biased to a Y axis positive direction side and the lower side pillar part 15B is biased to a Y axis negative side. Accordingly, only an FPC 90 with normal orientation, that is, only an FPC 90 oriented so that the surface side in which the conductor wire 96 is exposed is facing the vertical direction (Y axis direction) center of the first housing 11 can be inserted into the upper side board insertion recessed part 13A and the lower side board insertion recessed part 13B. In other words, even a normal type FPC 90 cannot be inserted when irregularly oriented, such as backwards.

Furthermore, when insertion of the FPC 90 into the first connector 10 is complete, the inside end part of the FPC 90 separation part 94 mates with the recessed connecting opening 13a3 that is a slit formed in the mating internal wall part 12e, and the locking protruding part 14b enters into and engages the locking opening part 93 formed at both ends in the width direction of the FPC 90. In this state, even if an external force is imparted so as to pull the FPC 90 backwards (X axis negative direction), the locking surface part 14b3 extending vertically (Z axis direction) formed on the front end of the locking protruding part 14b and the locking surface part 14b3 hooks on the front end of the locking opening part 93, and thus the locking of the locking protruding part 14b in the locking opening part 93 will not be released.

Furthermore, the window 13b1 having a notch shape is formed at a position corresponding to the locking protruding part 14b in the upper surface (Z axis positive direction surface) and the lower surface (Z axis negative direction surface) of the mating side part 12b enabling an operator to visually confirm whether a portion near both ends of the FPC 90 in the width direction is inserted into the end part insertion recessed part 13b of the mating side part 12b and that the locking protruding part 14b is engaged in the locking opening part 93 from outside the first connector 10. Additionally, when insertion of the FPC 90 into the first connector 10 is complete, the surface of the main mating plane 12d is covered with the FPC 90, enabling visual confirmation of the front end 90f reaching the front end protruding part 12a2 that protrudes from the main mating plane 12d from outside the first connector 10.

When the FPC 90 is thus completely inserted into the first connector 10, an operation then transitions the ISL 30 from being held temporarily to being held permanently. Specifically, the ISL 30 in the temporary holding position is raised relative to the main body part 11a of the first housing 11, and then, as is illustrated in FIG. 13 to FIGS. 15A and 15B, displaced to the permanent holding position. The locking spring part 33 is thus raised relatively along the side surface 11s of the main body part 11a. Additionally, when the locking spring part 33 rises relatively along the side surface 11s, the engaging beam part 33a comes in contact with the first engaging protruding part 17a. Here, because the inclined surface part 17c is formed on the lower end of the first engaging protruding part 17a, the engaging beam part 33a is able, while elastically displacing outward in the width direction of the first housing 11, to smoothly ride up over the first engaging protruding part 17a. Additionally, after riding up over the first engaging protruding part 17a, the engaging beam part 33a returns inward in the width direction of the first housing 11 through elastic force.

Thus, as is illustrated in FIG. 13 and FIGS. 14A-14C, the engaging beam part 33a engages the first engaging protruding part 17a in the permanent holding position, and the ISL 30 is permanently held in the first housing main body part 11a in the permanent holding position. In this state, not only does the engaging beam part 33a engage the first engaging protruding part 17a, but, because the upper surfaces of the main body part 31 and the protruding piece 32 make contact with the lower surface of the main body part 11a of the first housing 11, the ISL 30 is displaced vertically. Furthermore, the FPC holding pillar 34 is stowed inside the holding pillar stowing hole 16 from upper end to lower end. Accordingly, the ISL 30 does not rattle against the first housing 11.

Furthermore, because the ISL 30 is permanently held in the main body part 11a of the first housing 11 in the permanent holding position, as is illustrated in FIGS. 15A and 15B, for the FPC holding pillar 34 inserted in the holding pillar stowing hole 16 passing through the end part insertion recessed part 13b vertically, the slit part 34c is positioned at nearly the same height as the middle between the end part insertion recessed part 13b of the lower side board insertion recessed part 13B and the end part insertion recessed part 13b of the upper side board insertion recessed part 13A, and the upper side upper surface 35a, which is the upper end surface of the FPC holding pillar 34, is positioned at the same height, or below, the upper surface of the main body part 11a of the first housing 11. Thus, the engaging edge part 95b of the tab 95 of the lower side FPC 90B comes near, or makes contact with, the lower side engaging part 36b of the lower side block 34b, and the engaging edge part 95b of the tab 95 of the upper side FPC 90A comes near, or makes contact with, the upper side engaging part 36a of the upper side block 34a. That is, the engaging edge part 95b or the tab 95 comes near, or makes contact with, the engaging part 36.

Accordingly, in this state, even if an external force such as one that would pull the FPC 90 backward (X axis negative direction) is applied, because, as was described above, the locking opening part 93 is locked by the locking protruding part 14b and the engaging edge part 95b of the tab 95 is locked by the engaging part 36, the FPC 90 is not removed from the first connector 10. Note that when the recessed part 36c is formed in the engaging part 36, deformation is prevented near the engaging edge part 95b of the tab 95 because the engaging edge part 95b will advance into the recessed part 36c and vertical displacement thereof will be limited by the recessed part 36c if an external force such as one that would pull the FPC 90 backward were applied. Accordingly, even if such an external force that would pull the FPC 90 backward were strong, the FPC 90 is not removed from the first connector 10.

Thus, when the ISL 30 is permanently held in the main body part 11a of the first housing 11, the FPC 90 is completely mounted to the first connector 10. Additionally, the FPC 90 is reliably prevented from falling from the first connector 10.

A function of the ISL 30 that prevents the FPC 90 from being incorrectly or incompletely inserted is described next.

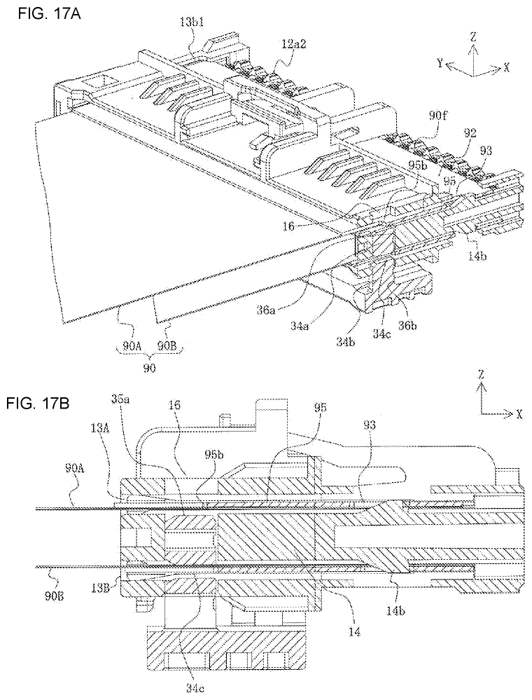

FIGS. 16A and 16B are two views illustrating a state of an ISL when the FPC is incorrectly, or incompletely, inserted into the first connector according to the present embodiment, and FIGS. 17A and 17B are cross sectional views illustrating a state of the ISL when the FPC is incorrectly, or incompletely, inserted into the first connector according to the present embodiment. Note that, in FIGS. 16A and 16B, FIG. 16A is a perspective view and FIG. 16B is a top view, and that, in FIGS. 17A and 17B, FIG. 17A is a perspective view that includes a cross sectional view along D-D in FIG. 16B, and FIG. 17B is a cross sectional view along D-D in FIG. 16B.

In recent years, electric and electronic devices have become smaller and more low profile and many parts have been miniaturized, as a result, the first connector 10 and the FPC 90 are also miniaturized, which makes it difficult for an operator to check the state of each part in the first connector 10 and the FPC 90 visually, by tactile sensation, or the like. Thus, incomplete insertion can occur, due to an operator incorrectly inserting the FPC 90 into the board insertion recessed part 13 of the first housing 11 in an irregular orientation, or ending an insertion operation before the FPC 90 is completely inserted into the board insertion recessed part 13 of the first housing 11. Additionally, even in cases where the FPC 90 has been inserted incorrectly or incompletely, it is difficult for an operator to confirm this visually, by tactile sensation, or the like.

However, with the ISL 30 according to the present embodiment, because the FPC 90 fails to displace from the temporary holding position to the permanent holding position when inserted incorrectly or incompletely, this enables an operator to confirm that the FPC 90 is inserted incorrectly or incompletely, which, as a result, prevents the FPC 90 from being inserted incorrectly or incompletely.

The ISL 30 according to the present embodiment can only displace from the temporary holding position to the permanent holding position when insertion into the upper side board insertion recessed part 13A of the upper side FPC 90A and into the lower side board insertion recessed part 13B of the lower side FPC 90B is completed, and thus cannot displace from the temporary holding position to the permanent holding position if, for some reason (for example, insertion of the FPC 90 in an irregular orientation, an operator incorrectly confirming that an FPC 90 insertion operation, despite being incomplete, is complete), insertion into the upper side board insertion recessed part 13A of the upper side FPC 90A and/or insertion into the lower side board insertion recessed part 13B of the lower side FPC 90B is not completed.

In the example illustrated in FIGS. 16A and 16B and FIGS. 17A and 17B, the state is such that, despite insertion into the lower side board insertion recessed part 13B of the lower side FPC 90B being completed, insertion into the upper side board insertion recessed part 13A of the upper side FPC 90A is, for some reason, not completed.

In this state, even if an operator attempts to transition the ISL 30 from being held temporarily, as is illustrated in FIGS. 16A and 16B and FIGS. 17A and 17B, to being held permanently, because the engaging edge part 95b of the tab 95 of the upper side FPC 90A is positioned inside the holding pillar stowing hole 16 and the upper side upper surface 35a thus makes contact near the engaging edge part 95b of the tab 95, the FPC holding pillar 34 cannot raise any further within the holding pillar stowing hole 16. Thus, even if an operator attempts to transition the ISL 30 from being held temporarily to being held permanently by raising the ISL relative to the main body part 11a of the first housing 11, the ISL 30 will not rise because the upper side upper surface 35a of the FPC holding pillar 34 makes contact near the engaging edge part 95b of the tab 95, that is, does not transition from being held temporarily to being held permanently, and the operator can reliably confirm that the FPC 90 is either inserted incorrectly or incompletely.

Additionally, an operator can confirm that the upper side FPC 90A is inserted incorrectly or incompletely by carefully checking the insertion state of the FPC 90, and then remove the cause of the incorrect or incomplete insertion to thus complete the insertion into the upper side board insertion recessed part 13A of the upper side FPC 90A. Next, when an operator raises the ISL 30, when in the temporary holding position, relative to the main body part 11a of the first housing 11, this creates a state where, as is illustrated in FIG. 13 to FIGS. 15A and 15B, the ISL 30 is permanently held in the first housing main body part 11a in the permanent holding position.

Furthermore, although not illustrated in the drawings, if insertion into the lower side board insertion recessed part 13B of the lower side FPC 90B is incomplete despite insertion into the upper side board insertion recessed part 13A of the upper side FPC 90A being complete, the ISL 30 cannot be transitioned from being held temporarily to be held permanently. In this state, because the engaging edge part 95b of the tab 95 of the lower side FPC 90B is positioned inside the slit part 34c of the FPC holding pillar 34 in the holding pillar stowing hole 16 and the lower side upper surface 35b thus makes contact near the engaging edge part 95b of the tab 95, the FPC holding pillar 34 does not rise any further inside the holding pillar stowing hole 16.

Additionally, the ISL 30 also cannot be transitioned from being held temporarily to be held permanently if insertion into the upper side board insertion recessed part 13A of the upper side FPC 90A is incomplete and insertion into the lower side board insertion recessed part 13B of the lower side FPC 90B is incomplete.

A variation of the ISL 30 is described next.

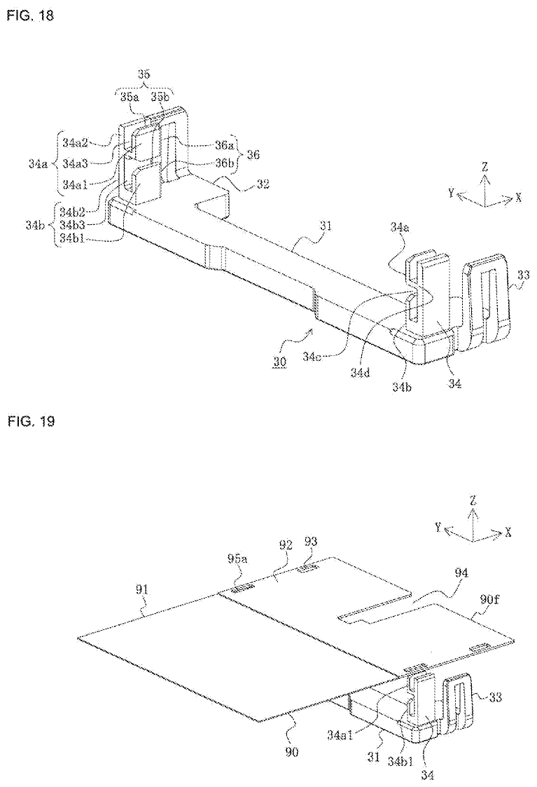

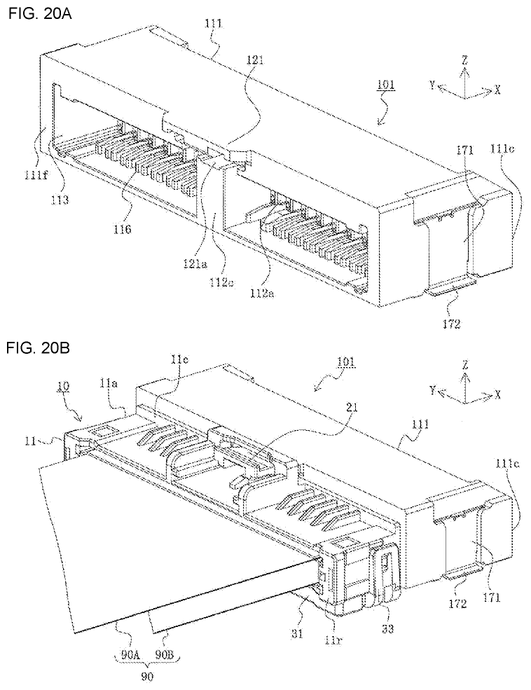

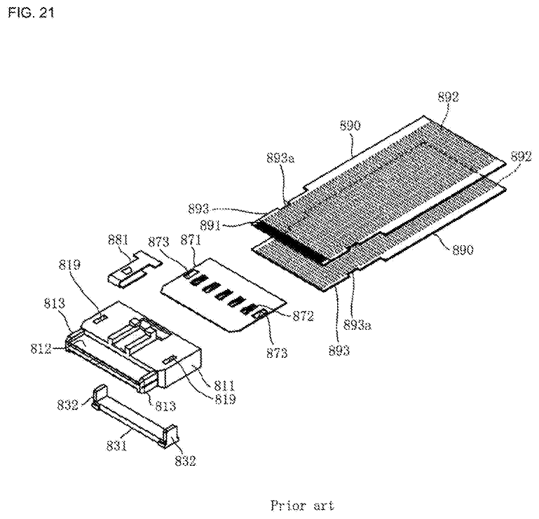

FIG. 18 is a perspective view illustrating a variation of the independent locking member according to the present embodiment and FIG. 19 is a perspective view illustrating a relationship near a tip end of the FPC corresponding to the variation of the independent locking member according to the present embodiment.

In the present embodiment, the first connector 10 can be used as a jacket, even if the FPC 90 is like the one illustrated in FIG. 19. The FPC 90 illustrated in FIG. 19, unlike the FPC 90 illustrated in FIG. 8 and FIGS. 9A and 9B, does not have the tab 95 protruding outward in the width direction formed thereon, and a dimension in the width direction (Y axis direction) in a prescribed length range from the front end 90f is the same as other portions. Furthermore, because the tab 95 is not formed, the engaging edge part 95b, which is a rear end of the tab 95, is also not present.

However, the notch 95a is also formed in the FPC 90 illustrated in FIG. 19 on both width direction ends of the FPC 90. The notch 95a penetrates the FPC 90 in a thickness direction (Z axis direction) and forms an opening (hole). Furthermore, a distance from the front end 90f to the notch 95a is the same as for the FPC 90 illustrated in FIG. 8, FIGS. 9A and 9B, and the like.

Note that because configurations of all other points of the FPC 90 illustrated in FIG. 19 are the same as those of the FPC 90 illustrated in FIG. 8 and FIGS. 9A and 9B, descriptions thereof are omitted.

Furthermore, the ISL 30 is configured as illustrated in FIG. 18 to thus correspond to the FPC 90 illustrated in FIG. 19. Specifically, the upper side block 34a in a left and right pair of the FPC holding pillars 34 is divided into an upper main body part 34a1 positioned inside in the width direction (Y axis direction) and an upper outside part 34a2 positioned outside in the width direction by an upper slit part 34a3 that extends front-to-back, and the lower side block 34b is divided into a lower main body part 34b1 positioned inside in the width direction and a lower outside part 34b2 positioned outside in the width direction by a lower slit part 34b3 that extends front-to-back. Additionally, the upper end surface of the upper main body part 34a1 is called the upper side upper surface 35a and the upper end surface of the lower main body part 34b1 is called the lower side upper surface 35b. Furthermore, the front end surface of the upper main body part 34a1 is called the upper side engaging part 36a and the front end surface of the lower main body part 34b1 is called the lower side engaging part 36b.

Additionally, when the ISL 30 is in the permanent holding position, the upper main body part 34a1 is inserted into the notch 95a of the upper side FPC 90A, the upper side engaging part 36a engages the notch 95a, the lower main body part 34b1 is inserted into the notch 95a of the lower side FPC 90B, and the lower side engaging part 36b engages the notch 95a. Moreover, when the ISL 30 is in the temporary holding position, the upper side upper surface 35a can be inserted through near both width direction ends of the upper side FPC 90A, and the lower side upper surface 35b can be inserted through near both width direction ends of the lower side FPC 90B.

Note that because configurations of all other points of the ISL 30 illustrated in FIG. 18 and FIG. 19 are the same as those of the ISL 30 illustrated in FIGS. 3A and 3B and FIGS. 4A-4E, descriptions thereof are omitted.

A configuration of the second connector 101, and an operation for mating the first connector 10 and the second connector 101 are described next.

FIGS. 20A and 20B are perspective views illustrating a second connector according to the present embodiment and a mated state between the first connector and the second connector. Note that in the figure, FIG. 20A is a view illustrating the second connector, and FIG. 20B is a view illustrating a mated state between the first connector and the second connector.

The second connector 101 according to the present embodiment includes a second housing 111 as a housing integrally formed using an insulating material such as synthetic resin, or the like, and a plurality of terminals (not shown) are formed by punching, bending, and the like, a conductive metal plate. The second connector 101 is a board connector mounted as a mounted member on the surface of a board (not shown) and mates with the first connector 10. In the example illustrated in the figure, the second connector 101 is a so-called right angle type. When mating with the first connector 10, the direction of movement relative to the first connector 10 is parallel to the surface of the board and it follows that the front surface 111f that is the mating surface of the second connector 101 second housing 111 is orthogonal to the surface of the board. Note that the second connector 101 does not necessarily need to be a right angle type and may be a so-called straight type where a direction of relative movement with respect to the first connector 10 when mated with the first connector 10 is perpendicular to the surface of the first board and the front surface 111f is parallel to the surface of the board as a mating surface in the second housing 111. However, for convenience of description, the case of a right angle type will be described.

As illustrated in the figure, the second housing 111 has a substantially rectangular body external shape elongated in the width direction (Y-axis direction). Furthermore, the second housing 111 includes a mating recessed section 113 that is open at the front surface 111f that is the mating surface for mating with the first connector 10. In addition, the second housing 111 includes side wall sections 111c formed at both ends in the width direction (Y axis direction) and auxiliary fittings 171 that are mounted to the side wall sections 111c for more reliable mounting on the board. The auxiliary fittings 171 are members formed by performing processing such as punching and bending of a metal plate and a tail section 172 is formed on the lower end as a board connecting part that extends outward in the width direction (Y axis direction). The tail section 172 is connected by soldering to a connection pad or the like formed on the surface of the board.

Moreover, a member to be locked 121 is formed in the center in the width direction (Y axis direction) of the upper surface (Z axis positive direction surface) of the second housing 111 as a mated state retaining device for retaining a mated state with the first connector 10. The member to be locked 121 is a member that engages and locks with the lock member 21 of the first connector 10 and includes a lock recessed section 121a that engages with the lock protruding section 21a of the lock member 21.

Furthermore, a mating column section 112c is formed in the center of the mating recessed section 113 in the width direction (Y axis direction) as a column section that mates with the mating recessed section 12c of the first connector 10. The mating column section 112c is a polygonal column shape member extending vertically (Z axis direction) directly under the member to be locked 121 and the front end surface thereof is formed so as to be flush with the front surface 111f. The mating column section 112c prevents deformation or twisting of the mating recessed section 113 in the vertical direction. In addition, when the second connector 101 is a straight type, the front end surface of the mating column section 112c can function as an adherence surface that a jig can adhere to.

Furthermore, in a state where the first connector 10 and the second connector 101 are mated, the mating column section 112c is stowed inside the mating recessed section 12c of the first connector 10 and the mating sections 11b divided into left and right by the mating recessed section 12c are respectively stowed in the mating recessed sections 113 divided into left and right by the mating column section 112c.

In addition, a plurality of terminal support sections 112a extending in the mating recessed sections 113 from the back to the front (X axis negative direction) are arranged lined up in the width direction. The upper and lower surfaces of the terminal supporting parts 112a have one terminal stowing groove each formed extending front-to-back, and each terminal is stowed in each terminal stowing groove. Additionally, a contact (not shown) of each of the terminals protrudes from the upper and lower surfaces of each of the terminal supporting parts 112a. Furthermore, a board connecting part (not shown) of each of the terminals protrudes from the rear part lower end of the second housing 111, and is connected by soldering to the connecting pad, or the like, formed on the surface of the board. Note that with the first connector 10 and the second connector 101 mated, the terminal supporting parts 112a is a member that enters the terminal insertion recessed part 12a1 of the first connector 10 and the quantity and pitch thereof are set to correspond to the quantity and pitch of the terminal insertion recessed part 12a1.

Furthermore, a plurality of long and narrow ribs 116 extending in the front-to-back direction protrude from the vertical surface inside the mating recessed sections 113. When the first connector 10 and the second connector 101 are mated, the FPC 90, which is inserted into the mating recessed sections 113 on the surface of the mating main planes 12d of the mating main section 12a, slides along the surface of the long and narrow ribs 116 reducing sliding resistance and therefore enabling smooth sliding.

Additionally, when the first connector 10 and the second connector 101 are mated, an operator first sets the front surface 11f that is the mating surface of the first housing 11 of the first connector 10 facing the front surface 111f that is the mating surface of the second connector 101 and adjusts the position of the mating part 11b of the first housing 11 of the first connector 10 to match the position of the mating recessed part 113 of the second housing 111 of the second connector 101. This completes positioning of the first connector 10 and the second connector 101.

Note that, for the first connector 10, the ISL 30 is permanently held in the main body part 11a of the first housing 11, and the upper side FPC 90A and the lower side FPC 90B are completely mounted. Furthermore, for the second connector 101, the terminal board connecting part and the tail part 172 of the auxiliary fitting 171 are mounted to the board surface by being connected by soldering to the connecting pad (not shown) on the board surface. Moreover, the connection pad to which the terminal board connecting part is connected to is assumed to connect to conductive traces on the board for transmitting electric current of signals and the like.

In this state, when the first connector 10 and/or second connector 101 are moved in a direction of approaching a counterpart side, that is, in a mating direction, mating starts, and the mating side part 12b of the first housing 11 enters into the mating recessed part 113. Thus, the mating pillar part 112c of the second housing 111 advances and mates inside the mating recessed part 12c of the first housing 11. Furthermore, the terminal supporting part 112a in the second housing 111 advances inside the terminal insertion recessed part 12a1 of the main mating part 12a of the first housing 11, the terminal contact part protruding upward from the upper surface of the terminal supporting part 112a comes into contact with the conductor wire 96 of the upper side FPC 90A, enabling conduction, and the terminal contact part that protrudes downward from the lower surface of the terminal supporting part 112a comes into contact with conductor wire 96 of the lower side FPC 90B, enabling conduction.

Thus, the first connector 10 and the second connector 101 are completely mated, each of the conductor wires 96 of the FPC 90 is in conduction with a corresponding terminal and electrically connected to a conductive trace on the board.

In this way, in the present embodiment, the first connector 10 is provided with the first housing 11 into which the FPC 90 can be inserted and the ISL 30 that can be mounted to the first housing 11; the ISL 30 includes the FPC holding pillar 34 that prevents removal of the FPC 90 and the locking spring part 33 that is held in the first housing 11; the FPC 90 includes the notch 95a formed at both width direction ends thereof, that is the notch 95a into which the FPC holding pillar 34 is inserted; the locking spring part 33 engages the first housing 11 and includes engaging beam part 33a that can hold the ISL 30 in the temporary holding position and the permanent holding position; and the FPC holding pillar 34 includes the upper surface 35 through which the FPC 90 can be inserted when the ISL 30 in the temporary holding position and the engaging part 36 that engages the notch 95a of the FPC 90 when the ISL 30 is in the permanent holding position.

Thus, the first connector 10, though small and low profile, exhibits high strength and can enhance reliability by making it easy to confirm that the FPC 90 has been completely inserted into the first housing 11, and by enabling simple, reliable, and correct mounting in a short period of time without the FPC 90 falling out. Additionally, because the ISL 30 is held in the temporary holding position when the FPC 90 is inserted into the first housing 11, the FPC 90 can be inserted more efficiently.

Furthermore, the locking spring part 33 is positioned further forward than the FPC holding pillar 34 in the FPC 90 insertion direction. In addition, the first housing 11 includes a pair of the engaging protruding parts 17 formed in the side 11s thereof, the locking spring part 33 includes a space 33b, and the engaging beam part 33a of the locking spring part 33 engages the second engaging protruding part 17b when the ISL 30 is in the temporary holding position and engages the first engaging protruding part 17a when the ISL 30 is in the permanent holding position. Additionally, the FPC 90 includes the locking opening part 93 formed closer to the front end 90f than the notch 95a, and the first housing 11 includes the locking protruding part 14b that engages the locking opening part 93. Finally, the FPC holding pillar part 34 includes a slit part 34c formed on a side thereof, and the upper surface 35 may be one of a plurality of surfaces that demarcate the perimeter of the slit part 34c.

Note that the disclosure herein describes features relating to suitable exemplary embodiments. Various other embodiments, modifications, and variations within the scope and spirit of the claims appended hereto will naturally be conceived of by those skilled in the art upon review of the disclosure herein.

The present disclosure can be applied to a FPC connector and a connector pair.

1. An FPC connector comprising:
(a) a jacket housing into which an FPC can be inserted; and
(b) an independent locking member that can be mounted to the jacket housing, wherein
(c) the independent locking member includes a locking part that prevents removal of the FPC and a holding part that is held in the jacket housing,
(d) the FPC includes a notch formed at both width direction ends thereof, that is a notch into which the locking part is inserted,
(e) the holding part includes an engaging part that engages the jacket housing and can hold the independent locking member in a temporary holding position and a permanent holding position, and
(f) the locking part includes an upper surface that enables the FPC to be inserted when the independent locking member is in the temporary holding position and an engaging part that engages the notch in the FPC when the independent locking member is in the permanent holding position.

2. The FPC connector according to claim 1 wherein, the holding part is positioned further forward in an insertion direction of the FPC than the locking part.

3. The FPC connector according to claim 1 wherein, the jacket housing includes a pair of protrusions formed on the front surface thereof, the holding part includes an opening part, the engaging part of the holding part engages one of the pair of protrusions when the independent locking member is in the temporary holding position, and engages the other of the pair of protrusions when the independent locking member is in the permanent holding position.

4. The FPC connector according to claim 1 wherein, the FPC includes an opening part formed closer to a front end than the notch, and the jacket housing includes a locking protruding part that engages the locking part.

5. The FPC connector according to claim 1 wherein, the locking part includes a slit part formed on a side surface thereof, and the upper surface thereof may be one of a plurality of surfaces that define a perimeter of the slit part.

6. A connector pair, comprising:
the FPC connector according claim 1 and a counterpart connector that mates with the FPC connector.
